(19) United States
(12) Patent Application Publication
(10) Pub. No.: US 2012/0088172 A1
(43) Pub. Date: Apr. 12, 2012

(54) FUEL CELL SYSTEM

(75) Inventors: Tomohiko Kaneko, Toyota-shi (JP); Hiroyuki Imanishi, Toyota-shi (JP); Yasuhiro Osada, Nagoya-shi (JP)

(73) Assignee: TOYOTA JIDOSHA KABUSHIKI KAISHA, Toyota-shi (JP)

(21) Appl. No.: 13/378,661

(22) PCT Filed: Jun. 18, 2009
(86) PCT No.: PCT/JP09/61104

§ 371 Date: Dec. 15, 2011

(51) Int. Cl. H01M 8/04

(52) U.S. Cl. 429/429; 429/434

(57) ABSTRACT

The power generation efficiency of a fuel cell system is improved. A fuel cell and an FC converter are integrally assembled so as to allow heat transfer therebetween, and are contained in the same casing. A control unit shifts a switching mode of a boost switch included in the FC converter from a soft switching mode to a hard switching mode when a temperature of the fuel cell is lower than a lower limit value of an allowable temperature range in accordance with an output of the fuel cell.

### TECHNICAL FIELD

The present invention relates to a fuel cell system.

### BACKGROUND ART

Patent Document 1 below discloses a fuel cell system in which a fuel cell is integrated with a DC-DC converter being a voltage converter unit. In this fuel cell system, the integration of the fuel cell and the DC-DC converter enables the state of each of the unit cells in the fuel cell to be monitored easily, and a power generation current is controlled in accordance with the state of each unit cell being monitored. Further, a printed circuit board is arranged between a boost switch included in the DC-DC converter and the fuel cell, thereby preventing the on resistance of the boost switch from being increased due to heat from the fuel cell.

### PRIOR ART REFERENCE

### Patent Document

Patent Document 1: JP2007-207582 A

### SUMMARY OF THE INVENTION

### Problem to be Solved by the Invention

In a fuel cell system, a temperature variation of a fuel cell is required to be reduced as much as possible in order to realize efficient operation. However, the temperature of the fuel cell may decrease due to the influence of, for example, outdoor air. In such a case, for example, condensation may occur in the fuel cell, leading to a reduction in the power generation efficiency.

The present invention has been made to solve the above problem in the prior art, and an object of the present invention is to provide a fuel cell system that is capable of improving the power generation efficiency.

### Means for Solving the Problem

In order to solve the above problem, the present invention provides a fuel cell system, including: a fuel cell that is supplied with a fuel gas and an oxidant gas and generates electric power through an electrochemical reaction between the fuel gas and the oxidant gas; a power-consuming apparatus that consumes power from the fuel cell; a voltage converter unit that is configured to allow heat transfer with the fuel cell and that boosts an output voltage of the fuel cell to supply the boosted output voltage to the power-consuming apparatus; and control means that sets a switching mode of a boost switching element included in the voltage converter unit to a hard switching mode when a temperature of the fuel cell is lower than a lower limit value of an allowable temperature range in accordance with an output of the fuel cell, wherein the switching mode includes a soft switching mode and the hard switching mode.

According to the invention, when the temperature of the fuel cell is lower than the allowable temperature in accordance with the output of the fuel cell, the switching mode of the boost switching element can be set to the hard switching mode. Therefore, the fuel cell can be warmed up utilizing heat generated in the boost switching element.

In the fuel cell system above, the control means may set the switching mode to the hard switching mode in an attempt to start the fuel cell system at a low temperature.

With such a configuration, the fuel cell can be warmed up utilizing heat generated in the boost switching element in an attempt to start the fuel cell system at a low temperature.

In the fuel cell system above, when the switching mode is the hard switching mode and before the rising temperature of the fuel cell falls within the allowable temperature range in accordance with the output of the fuel cell, the control means may shift the switching mode from the hard switching mode to the soft switching mode.

Such a configuration can prevent overshooting from occurring due to an excessive rise in the temperature of the fuel cell.

In the fuel cell system above, when the temperature of the fuel cell falls within the allowable temperature range in accordance with the output of the fuel cell, and the temperature of the fuel cell has decreased beyond a predetermined upper-limit decreasing rate in the soft switching mode employed as the switching mode, the control means may shift the switching mode from the soft switching mode to the hard switching mode.

With such a configuration, the temperature of the fuel cell can be prevented from decreasing excessively.

In the fuel cell system above, the fuel cell and the voltage converter unit may be integrally assembled to allow heat transfer between the fuel cell and the voltage converter unit.

### Effect of the Invention

According to the invention, the power generation efficiency can be improved.

### BRIEF DESCRIPTION OF THE DRAWINGS

FIG. 1 is a schematic diagram of a configuration of a fuel cell system according to an embodiment.

FIG. 2 is a flowchart illustrating the flow of switching mode control processing according to the embodiment.

FIG. 3 is a flowchart illustrating the flow of switching mode control processing for starting according to a modification.

### BEST MODE FOR CARRYING OUT THE INVENTION

A preferred embodiment of a fuel cell system according to the present invention will be described below with reference to the attached drawings. The following description describes an embodiment in which the fuel cell system according to the present invention is used as an in-vehicle power generation system in a fuel cell hybrid vehicle (FCHV). Note that the fuel cell system according to the present invention may also be applied to various mobile objects (e.g., robots, ships and airplanes) other than fuel cell hybrid vehicles. In addition, the fuel cell system according to the present invention may be applied to stationary power generation systems used as power generating equipment for constructions (e.g., houses and buildings).

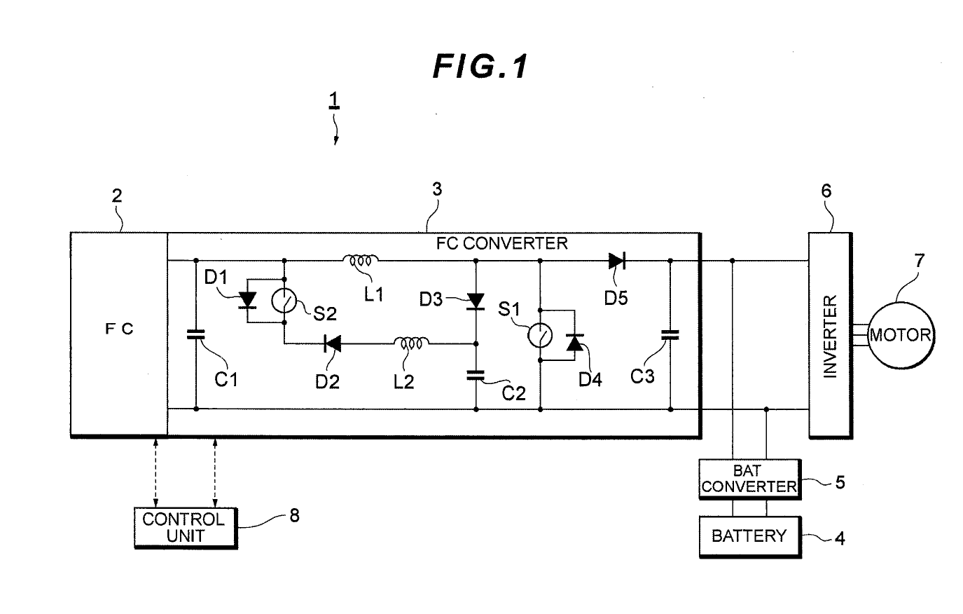

First, the configuration of the fuel cell system in the embodiment will be described with reference to FIG. 1. FIG. 1 is a schematic diagram of the fuel cell system according to the embodiment.

As shown in FIG. 1, a fuel cell system 1 has: a fuel cell 2 that generates electric power through an electrochemical reaction between an oxidant gas and a fuel gas serving as reactant gases; an FC converter 3 (voltage converter unit) being a DC/DC converter for a fuel cell; a battery 4 serving as a secondary battery: a BAT converter 5 being a DC/DC converter for a battery: a traction inverter 6 serving as a load; a traction motor 7 (power-consuming apparatus); and a control unit 8 (control means) that centrally controls the entire system. The fuel cell 2 and the FC converter 3 are integrally assembled to allow heat transfer therebetween, and are contained in the same casing. Note that the fuel cell 2 and the FC converter 3 are not necessarily contained in the same casing. For example, the fuel cell 2 and the FC converter 3 may be contained in separate casings, and may then be coupled to each other by providing a mechanism that allows heat exchange between the casings.

The fuel cell 2 is, for example, a polymer electrolyte type fuel cell, which has a stack structure with a lot of unit cells stacked therein. Each unit cell has an air electrode on one surface of an electrolyte membrane constituted from an ion-exchange membrane and a fuel electrode on the other surface of the electrolyte membrane, and the unit cell further has a pair of separators which sandwich the air electrode and the fuel electrode therebetween. In this configuration, a hydrogen gas is supplied to a hydrogen gas path of one separator while the oxidant gas is supplied to an oxidant gas path of the other separator, and electric power is generated through a chemical reaction between these reactant gasses.

The FC converter 3 is a direct-current voltage converter, and has a function of boosting a direct-current voltage output from the fuel cell 2 and outputting the resultant direct-current voltage to the traction inverter 6 and the traction motor 7. The FC converter 3 controls an output voltage of the fuel cell 2.

The FC converter 3 is configured to include, for example: a smoothing capacitor C1 that smoothes a direct-current voltage input from the fuel cell 2; a boost coil L1 and a boost switch S1 (boost switching element) for boosting a direct-current voltage; a resonant capacitor C2 and a resonant coil L2 that constitute a resonant circuit; a resonant switch S2 that turns the resonant circuit on/off; and a smoothing capacitor C3 that smoothes an output voltage of the FC converter 3. In this embodiment, soft switching of the boost switch S1 is attained by providing the resonant circuit. The details of soft switching will be described below.

The battery 4 includes stacked battery cells and provides a certain high voltage as a terminal voltage, the battery 4 being capable of being charged with surplus power of the fuel cell 2 and supplying electric power in an auxiliary manner under the control of a battery computer (not shown). The BAT converter 5 is a direct-current voltage converter, and has a function of regulating (boosting) a direct-current voltage output from the battery 4 and outputting the resultant direct-current voltage to the traction inverter 6 and the traction motor 7 and a function of regulating (reducing) a direct-current voltage output from the fuel cell 2 or the traction motor 7 and outputting the resultant direct-current voltage to the battery 4. These functions of the BAT converter 5 charge and discharge the battery 4.

The traction inverter 6 converts a direct current to a three-phase alternating current, and supplies the three-phase alternating current to the traction motor 7. The traction motor 7 is, for example, a three-phase alternating current motor, which serves as a main power source for a fuel cell hybrid vehicle equipped with the fuel cell system 1.

The control unit 8 detects the amount of operation of an acceleration member (e.g., accelerator pedal) provided in the fuel cell hybrid vehicle and controls the operations of various appliances in the system upon the receipt of control information such as a required acceleration value (e.g., the amount of power generation required by power-consuming apparatuses such as the traction motor 7). Note that examples of the power-consuming apparatuses include, in addition to the traction motor 7: auxiliary apparatuses required for operating the fuel cell 2 (e.g., motors for a compressor and a hydrogen pump); actuators used in various apparatuses relevant to the travel of the vehicle (e.g., a speed change gear, a wheel control apparatus, a steering gear and a suspension); and an air-conditioning apparatus (air conditioner), lighting equipment and an audio system in a passenger compartment.

The control unit 8 physically includes, for example, a CPU, a memory and an input-output interface. The memory includes: a ROM that stores a control program and control data which are processed by the CPU; and a RAM primarily used as various work areas for control processing. These elements are connected to each other via a bus. The input-output interface is connected to various sensors such as a voltage sensor, and is connected to various drivers for driving the traction motor 7, etc.

The CPU executes various kinds of control processing in the fuel cell system 1 by receiving detection results from the various sensors via the input-output interface and processing the received detection results using various pieces of data, etc., in the RAM, based on the control program stored in the ROM. Further, the CPU controls the entire fuel cell system 1 by outputting control signals to the various drivers via the input-output interface.

The control unit 8 sets a switching mode of the boost switch S1, and carries out switching control over the boost switch S1 in accordance with the set switching mode. The switching mode of the boost switch S1 includes a hard switching mode and a soft switching mode. The hard switching mode is a mode in which the boost switch S1 is turned on/off in accordance with control instructions regardless of a voltage or current value. The soft switching mode is a mode in which: a potential difference between switch terminals is made zero so as to prevent a current from flowing between the terminals; and the boost switch S1 is then turned on/off.

The procedures of soft switching performed by the control unit 8 during the soft switching mode will be described. Soft switching in this embodiment is performed to eliminate a switching loss that occurs when the boost switch S1 is turned on/off.

First, when the boost switch S1 is to be switched from on to off, the boost switch S1 is gradually switched from on to off (procedure 1). Thus, a current flowing through the boost switch S1 is reduced, so that a current comes to converge toward the diode D3 and the resonant capacitor C2.

Then, after the current flowing through the boost switch S1 becomes zero, the boost switch S1 is completely switched from on to off (procedure 2). Thus, the boost switch S1 can be turned off when any current does not flow through the boost switch S1, and therefore the switching loss can be made zero.

Meanwhile, a current flows into the resonant capacitor C2, so that electric charge is accumulated in the resonant capacitor C2.

Next, the resonant switch S2 is switched from off to on in order to release the electric charge accumulated in the resonant capacitor C2 (procedure 3). Thus, a current flows into the smoothing capacitor C1 from the resonant capacitor C2 via the resonant coil L2 and a diode D2, so that electric charge is accumulated in the smoothing capacitor C1. That is, a current flows from the resonant circuit into the smoothing capacitor C1, so that electric charge is accumulated in the smoothing capacitor C1.

All the electric charge is then released from the resonant capacitor C2, so that the voltage of the resonant capacitor C2 becomes zero. Then, the potential difference between the two ends of a series circuit constituted by the diode D3 and the resonant capacitor C2 becomes zero, and the potential difference between the two ends of the boost switch S1 also becomes zero.

After the electric potential difference between the two ends of the boost switch S1 becomes zero, the boost switch S1 is switched from off to on (procedure 4). Thus, the boost switch S1 can be turned on when any current does not flow through the boost switch S1, and therefore the switching loss can be made zero.

The control unit 8 sets the switching mode of the boost switch S1 to the hard switching mode when, for example, conditions (1) and (2) below are satisfied. That is, the switching mode is shifted from the soft switching mode to the hard switching mode.

(1) The case where a temperature of the fuel cell 2 is lower than a lower limit value of an allowable temperature range in accordance with the output of the fuel cell 2. As the temperature of the fuel cell 2, for example, a detection value of a temperature sensor that measures the temperature of the fuel cell 2, or a detection value of a temperature sensor that measures the temperature of cooling water for cooling the fuel cell 2, can be used. The allowable temperature range in accordance with the output of the fuel cell 2 is obtained by, for example, finding, for each output of the fuel cell 2, a possible value range of the temperature of the fuel cell 2 that could be determined as providing performance in accordance with the output through experiments, etc. The obtained allowable temperature range is stored in a map based on associations with the outputs of the fuel cell 2, and the map is stored in the memory.

(2) The case where a temperature of the fuel cell 2 falls within the allowable temperature range in accordance with the output of the fuel cell 2, and the temperature of the fuel cell 2 has decreased beyond a predetermined upper-limit decreasing rate. As the predetermined upper-limit decreasing rate, for example, an upper-limit decreasing rate can be set which is capable of continuing the operation without reducing the power generation efficiency by shifting the switching mode to the hard switching mode when the temperature of the fuel cell 2 reaches the lower limit value of the allowable temperature range even if the temperature of the fuel cell 2 continues to be reduced at the present decreasing rate.

The control unit 8 sets the switching mode of the boost switch S1 to the soft switching mode when the temperature of the fuel cell 2 falls within the allowable temperature range in accordance with the output of the fuel cell 2, and condition (2) above does not apply. That is, the switching mode is shifted from the hard switching mode to the soft switching mode. Note that the control unit 8 sets the switching mode of the boost switch S1 to the soft switching mode when the temperature of the fuel cell 2 is higher than the allowable temperature range in accordance with the output of the fuel cell 2.

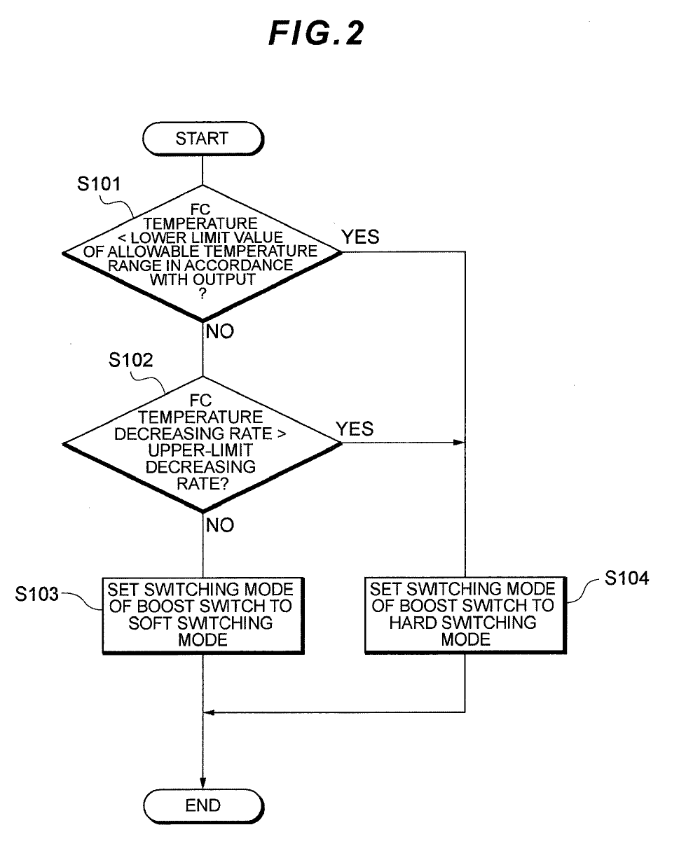

Next, switching mode control processing in this embodiment will be described with reference to the flowchart in FIG. 2. This switching mode control processing is, for example, repeatedly performed until the operation stops after an ignition key is turned on.

First, the control unit 8 determines whether or not the temperature of the fuel cell 2 is lower than the lower limit value of the allowable temperature range in accordance with the output of the fuel cell 2 (step S101). If the result of the determination is YES (step S101: YES), the control units 8 sets the switching mode of the boost switch S1 to the hard switching mode (step S104).

Meanwhile, if the determination in step S101 above results in that the temperature of the fuel cell 2 is equal to or higher than the lower limit temperature of the allowable temperature range in accordance with the output of the fuel cell 2 (step S101: NO), the control unit 8 then determines whether or not the decreasing rate of the temperature of the fuel cell 2 is above the upper-limit decreasing rate (step S102). If the result of the determination is YES (step S102: YES), the control unit 8 sets the switching mode of the boost switch S1 to the hard switching mode (step S104).

Meanwhile, if the determination in step S102 above results in that the decreasing rate of the temperature of the fuel cell 2 is equal to or lower than the upper-limit decreasing rate (step S102: NO), the control unit 8 sets the switching mode of the boost switch S1 to the soft switching mode (step S103).

As described above, according to the fuel cell system 1 in this embodiment, when the temperature of the fuel cell 2 is lower than the allowable temperature in accordance with the output of the fuel cell 2, the switching mode of the boost switch S1 can be set to the hard switching mode, and thus the fuel cell 2 can be warmed up utilizing heat generated in the boost switch S1. Therefore, the power generation efficiency of the fuel cell system 1 can be improved.

Further, when the temperature of the fuel cell 2 reaches the allowable temperature in accordance with the output of the fuel cell 2, the switching mode of the boost switch S1 can be set to the soft switching mode. Therefore, the switching loss that occurs when the boost switch S1 is turned on/off can be eliminated.

Further, when the temperature of the fuel cell falls within the allowable temperature range in accordance with the output of the fuel cell 2, and the temperature of the fuel cell 2 has been reduced beyond the predetermined upper-limit decreasing rate in the soft switching mode as the switching mode, the switching mode can be shifted from the soft switching mode to the hard switching mode. Therefore, the temperature of the fuel cell 2 can be prevented from decreasing excessively.

Note that, in the above embodiment, the switching mode control processing for the boost switch S1 is repeatedly performed during the operation of the fuel cell system; however, the processing is not limited thereto. For example, switching mode control processing for starting, which will be described below, may be performed in an attempt to start the fuel cell system. This switching mode control processing for starting may be performed in combination with the switching mode control processing in the embodiment, or only the switching mode control processing for starting may be performed.

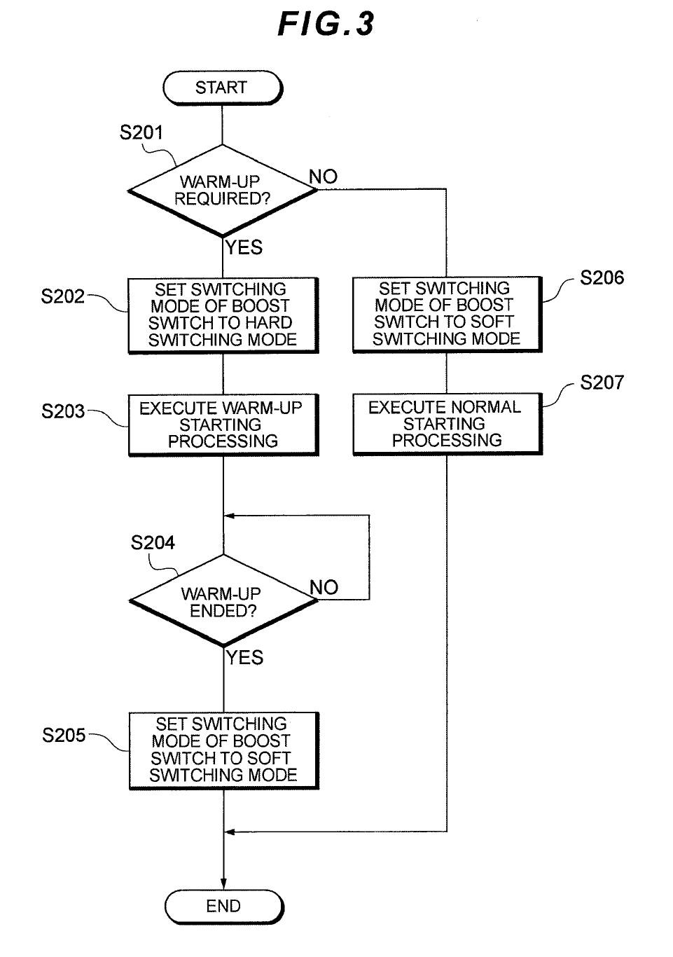

Switching mode control processing for starting in a modification will be described with reference to the flowchart in FIG. 3. This switching mode control processing for starting is executed once, for example, when the ignition key is turned on.

First, the control unit 8 determines whether or not a warm-up is required (step S201). Whether or not a warm-up is required can be determined based on, for example, whether or not an outdoor temperature is so low as to cause produced water in the fuel cell to freeze without any warm-up. If the result of the determination is NO (step S201: NO), the control unit 8 sets the switching mode of the boost switch S1 to the soft switching mode (step S207), and then executes normal starting processing (step S208). Meanwhile, if the determination in step S201 above results in a warm-up is required (step S201: YES), the control unit 8 sets the switching mode of the boost switch S1 to the hard switching mode (step S202), and then executes warm-up starting processing (step S203).

The control unit 8 then determines whether or not the warm-up has been ended (step S204). If the result of the determination is NO (step S204: NO), the control unit 8 repeatedly executes this determination processing. Meanwhile, if the determination in step S204 above results in that the warm-up has been ended (step S204: YES), the control unit 8 sets the switching mode of the boost switch S1 to the soft switching mode (step S205).

Thus, the switching mode of the boost switch S1 can be set to the hard switching mode when the fuel cell system is to be started at a low temperature with the need for a warm-up. Therefore, the fuel cell 2 can be warmed up utilizing heat generated when the boost switch S1 is turned on/off. Further, when the fuel cell has been warmed up after the end of the warm-up, the switching mode of the boost switch S1 can be set to the soft switching mode. Therefore, the switching loss that occurs when the boost switch S1 is turned on/off can be eliminated.

Furthermore, although the above embodiment employs the condition that the temperature of the fuel cell 2 falls within the allowable temperature range in accordance with the output of the fuel cell 2 when the switching mode of the boost switch S1 is shifted from the hard switching mode to the soft switching mode, the temperature of the fuel cell 2 falling within the allowable temperature range is not necessarily made a condition. For example, even if the temperature of the fuel cell 2 is lower than the lower limit value of the allowable temperature range, when the temperature of the fuel cell 2 is on the rise, and also the temperature of the fuel cell 2 is expected to reach the allowable temperature range even after a shift to the hard switching mode, the switching mode of the boost switch S1 may be set to the soft switching mode before the temperature of the fuel cell 2 reaches the allowable temperature range. Thus, overshooting can be prevented from occurring due to an excessive rise in the temperature of the fuel cell 2. Here, whether or not the temperature of the fuel cell 2 reaches the allowable temperature range can be determined by, for example, using the present temperature and present temperature increasing rate of the fuel cell, the amount of heat generated from the boost switch S1, etc.

### INDUSTRIAL APPLICABILITY

The fuel cell system according to the present invention is suitable for improving the power generation efficiency.

### Description of Reference Numerals

1: fuel cell system, 2: fuel cell, 3: FC converter, 4: battery, 5: BAT converter, 6: traction inverter, 7: traction motor, 8: control unit, C1, C3: smoothing capacitor, C2: resonant capacitor, L1: boost coil, L2: resonant coil, S1: boost switch, S2: resonant switch

1.-5. (canceled)

6. A fuel cell system, comprising:
a fuel cell that is supplied with a fuel gas and an oxidant gas and generates electric power through an electrochemical reaction between the fuel gas and the oxidant gas;
a power-consuming apparatus that consumes power from the fuel cell;
a voltage converter unit that is configured to allow heat transfer with the fuel cell and that boosts an output voltage of the fuel cell to supply the boosted output voltage to the power-consuming apparatus; and
a control unit that sets a switching mode of a boost switching element included in the voltage converter unit to a hard switching mode when a temperature of the fuel cell is lower than a lower limit value of an allowable temperature range in accordance with an output of the fuel cell,
wherein the switching mode includes a soft switching mode and the hard switching mode,
wherein, when the switching mode is the hard switching mode and before the rising temperature of the fuel cell falls within the allowable temperature range in accordance with the output of the fuel cell, the control unit shifts the switching mode from the hard switching mode to the soft switching mode.

7. The fuel cell system according to claim 6, wherein, when the temperature of the fuel cell falls within the allowable temperature range in accordance with the output of the fuel cell, and the temperature of the fuel cell has decreased beyond a predetermined upper-limit decreasing rate in the soft switching mode employed as the switching mode, the control unit shifts the switching mode from the soft switching mode to the hard switching mode.

8. The fuel cell system according to claim 6, wherein the control unit sets the switching mode to the hard switching mode in an attempt to start the fuel cell system at a low temperature.

9. The fuel cell system according to claim 6, wherein the fuel cell and the voltage converter unit are integrally assembled to allow heat transfer between the fuel cell and the voltage converter unit.

10. A fuel cell system, comprising:
a fuel cell that is supplied with a fuel gas and an oxidant gas and generates electric power through an electrochemical reaction between the fuel gas and the oxidant gas;
a power-consuming apparatus that consumes power from the fuel cell;
a voltage converter unit that is configured to allow heat transfer with the fuel cell and that boosts an output voltage of the fuel cell to supply the boosted output voltage to the power-consuming apparatus; and
control unit that sets a switching mode of a boost switching element included in the voltage converter unit to a hard switching mode when a temperature of the fuel cell is lower than a lower limit value of an allowable temperature range in accordance with an output of the fuel cell,
wherein the switching mode includes a soft switching mode and the hard switching mode, and
wherein, when the temperature of the fuel cell falls within the allowable temperature range in accordance with the output of the fuel cell, and the temperature of the fuel cell has decreased beyond a predetermined upper-limit decreasing rate in the soft switching mode employed as the switching mode, the control unit shifts the switching mode from the soft switching mode to the hard switching mode.

11. The fuel cell system according to claim 10, wherein the control unit sets the switching mode to the hard switching mode in an attempt to start the fuel cell system at a low temperature.

12. The fuel cell system according to claim 10, wherein the fuel cell and the voltage converter unit are integrally assembled to allow heat transfer between the fuel cell and the voltage converter unit.
